(19) United States
(12) Patent Application Publication
(10) Pub. No.: US 2018/0200574 A1
(43) Pub. Date: Jul. 19, 2018

(54) UPPER BODY WORKOUT DEVICE

(71) Applicant: KELLY JEAN CONNOLLY, Los Angeles, CA (US)

(72) Inventor: KELLY JEAN CONNOLLY, Los Angeles, CA (US)

(21) Appl. No.: 15/727,623

(22) Filed: Oct. 8, 2017

Related U.S. Application Data
(60) Provisional application No. 62/406,945, filed on Oct. 12, 2016.

(51) Int. Cl. A63B 23/12; A61H 15/00; A63B 21/00; A63B 21/008; A63B 21/02; A63B 23/035; A63B 24/00

(52) U.S. Cl. CPC A63B 23/12; A61H 15/0092; A63B 21/00043; A63B 21/00178; A63B 21/00185; A63B 21/00192; A63B 2225/20; A63B 21/028; A63B 21/4035; A63B 23/03525; A63B 24/00; A63B 2210/50; A63B 2225/09; A63B 21/0083

(57) ABSTRACT

A workout device is disclosed that primarily focuses on the upper body such as arms, shoulders, pectoral and abdominal muscles but can also be used for exercising legs, ankles, and back muscles as well. The device is a cylindrical base comprised of a combination of metal, aluminum, plastic, Eco-friendly “Super Plastics,” rubber, carbon fiber, or the like and will be approximately two feet in length (but may be shorter or longer), an internal bladder, a plunger, a set of retractable handles with neoprene grips on each end, and an adjustable two-way pneumatic air resistance air valve.

The device will be light weight, collapsible and portable sized to fit easily inside briefcases, carry-on luggage, totes and most women's purses. It will be packaged in eco-friendly, functional packaging such as an over-the-shoulder bag that can be used to transport the device on the go. Both male and female styles will be available.

The device can be collapsible to fit in a pants pocket with a hinged part and can be offered in an array of sizes, muscle strength capacity, and diameters.

The device may create resistance by pneumatics, hydraulics, magnetics, or spring action or a combination of all four means and methods. The device may comprise an electronic circuitry internally powered by a lithium-ion battery, externally rechargeable. Said circuitry to contain a bluetooth transceiver in order to transfer or download data from the device to a smart phone, tablet or other computing type device, to maintain a record of the number of repetitions, time, date, and so to then calculate calories burned during a particular session or period of time and to then store said data within an internal memory storage device.

This invention comprises a tubular component approximately 2 feet long that internally houses the air intake shaft and plunger, the adjustable valves which controls the force required to move the plunger in and out that create a body weight resistance that increases muscle mass by requiring the user to exert more force to compress and uncompress. The end parts are comprised of neoprene type grips that are made of polymer rubber which is resistant to oil, heat, and weathering. These neoprene type grips rotate 45 degrees or more, and snap into place with a ball bearing that locks into a slot, such that the user can change the angle of the movement for various muscle groups.

The inventive step is in creating a pneumatic or hydraulic compression or vacuum chamber that has a means of adjusting the force required to stretch or compress the end handle grips by allowing the user to adjust the force by utilizing two valves that can restrict airflow in each direction of travel.

### A BRIEF DESCRIPTION OF THE DRAWINGS

FIG. 1 depicts the invention as might be found in the preferred embodiment in certain exercises and muscle groups in the ready to travel configuration, for example.

FIG. 2 depicts the invention from a side view depicting the swivel handles in their folded configuration as might be found in the preferred embodiment for example.

FIG. 3 depicts the internal components of the present invention as might be found in the preferred embodiment for example.

FIG. 4 shows the front view of the invention in its ready to use configuration as might be found for certain exercises and muscle groups in the preferred embodiment for example.

FIG. 5 depicts the side view of the present invention for certain exercises and muscle groups in the configuration as might be found in the preferred embodiment for example.

FIG. 6 depicts the invention comprising a printed circuit board, component parts, and a battery for powering the internal circuits. The added circuitry includes a reed switch that can connect to a smart phone via bluetooth to determine the number of repetitions, the duration of the workout, the number of calories burned and other facts associated with the user and the specific usage of the device from time to time. The data is stored on the internal memory for later recall by the smart phone app.

FIG. 7 depicts the workout device showing an added feature comprising a wrap around velcro brand attached leg muscle rolling pin type rubber attachment that can be used to roll out leg cramps or leg muscle stiffness associated with a strenuous physical workout for example in the preferred embodiment.

FIG. 8 depicts the device comprising an internal metal or rubber spring type stretch material that can be used in place of the pneumatic plunger and adjustment valves for example in the preferred embodiment.

FIG. 9 depicts the device with the use of two magnets that restrict movement by passing along the length of the cylindrical base part that contains the plunger and piston wherein the piston is magnetic

FIG. 10 depicts the internal side view of the hollow tube comprising the adjustable magnets that pass over the permanent magnets of the piston rod to create a greater or lesser resistance for the user of the device for example.

FIG. 11 depicts the two replacement handles resembling stirrups, that can be used for lower body workout exercises as well as upper body workouts, for example.

### A DETAILED DESCRIPTION OF THE DRAWINGS

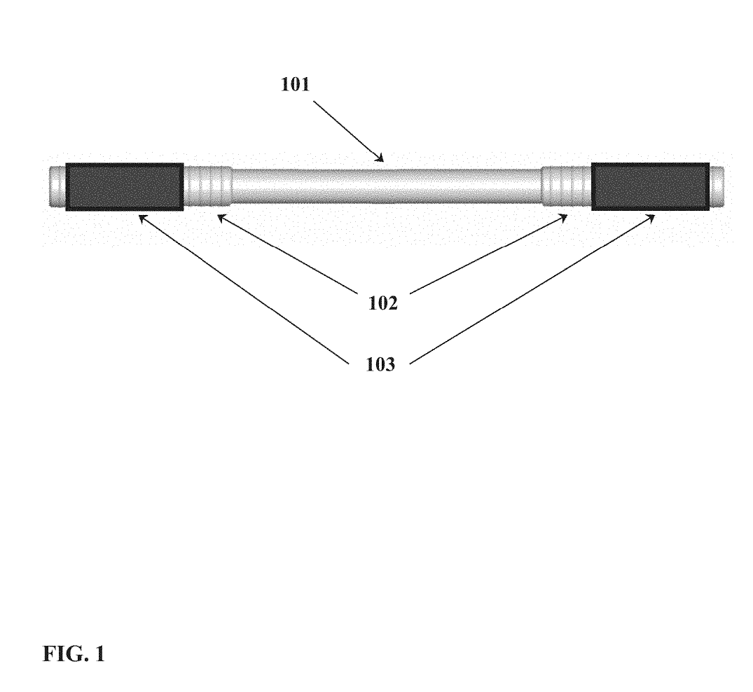

FIG. 1 depicts the top view of the invention wherein (101) shows the main tube comprising the plunger, the adjustable pressure valve(s), the (102) neoprene rotatable handle grips, and the (103) removable grip sleeves.

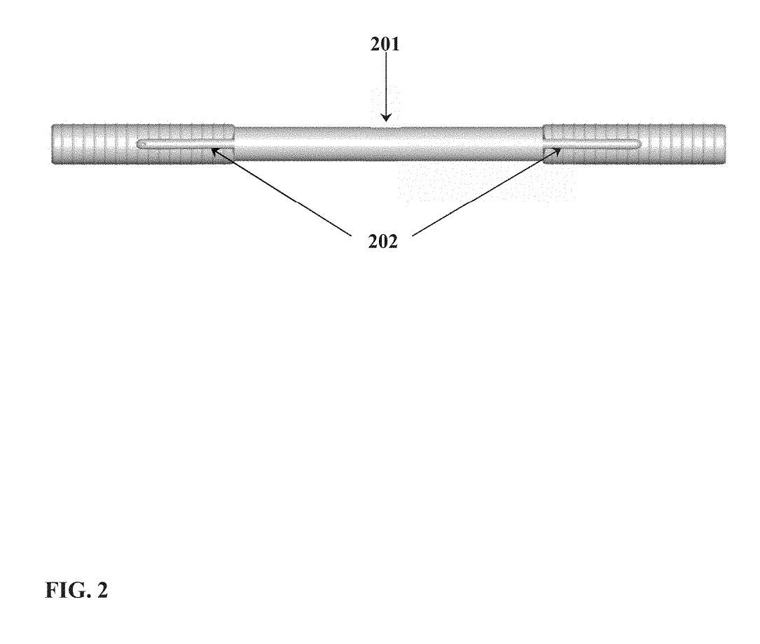

FIG. 2 depicts the side view of the present invention wherein the (201) main tube is attached to the two slotted (202) end grips which are able to be intended and rotated on a swivel to allow the user to change the angle of the grip for various exercise routines.

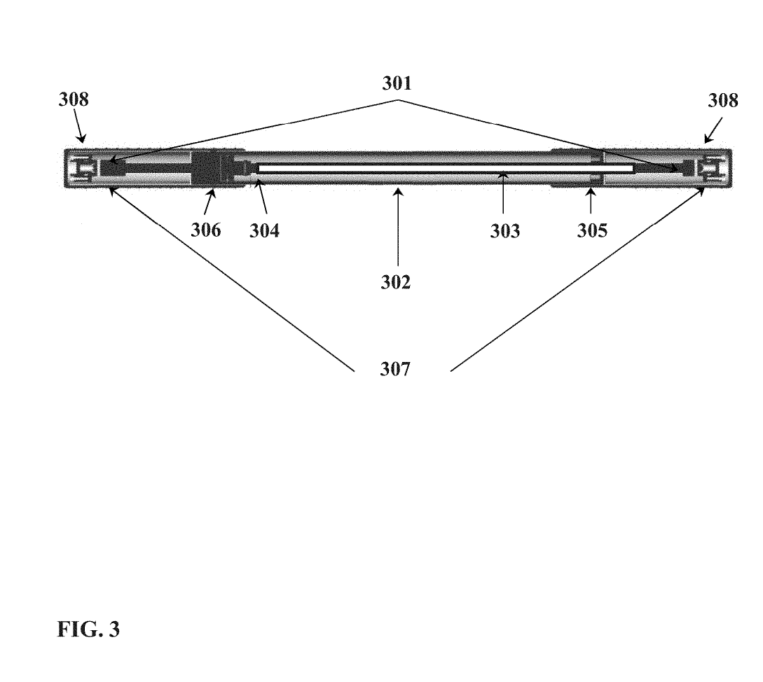

FIG. 3 depicts the internal view (301) of the hollow tube (302) comprising the shaft (303), the plunger (304), the pressure seal (305), the adjustment valve (306), and the rotatable swivel hand grips (307), and the tension springs (308).

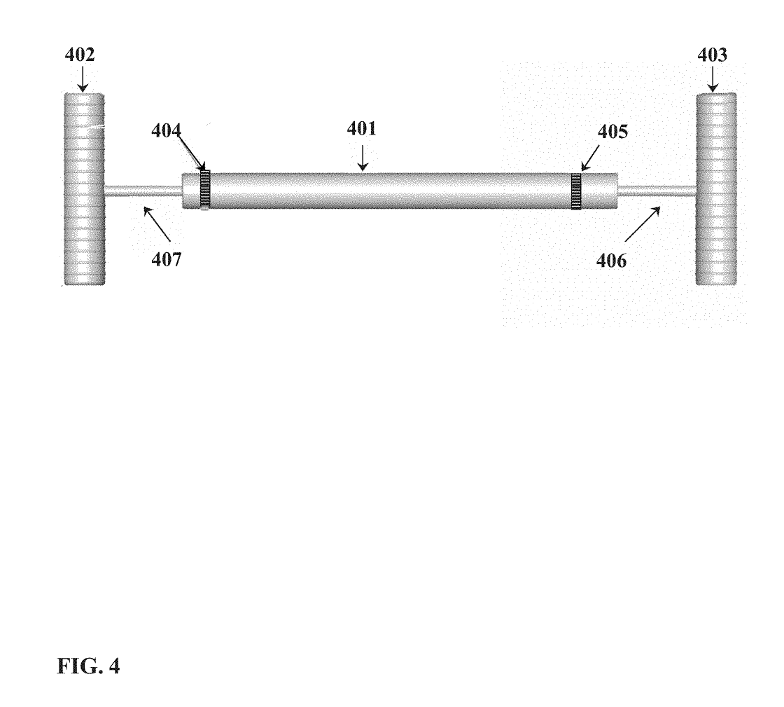

FIG. 4 depicts the hollow tube (401) comprising, the grip handles extended and rotated (402, 403), the adjustable pressure rotatable adjustable pressure out ring (404), the adjustable pressure in ring (405), and the piston shaft on the air input port side (406), and the piston shaft on the air output side (407), as might be found in the preferred embodiment for example.

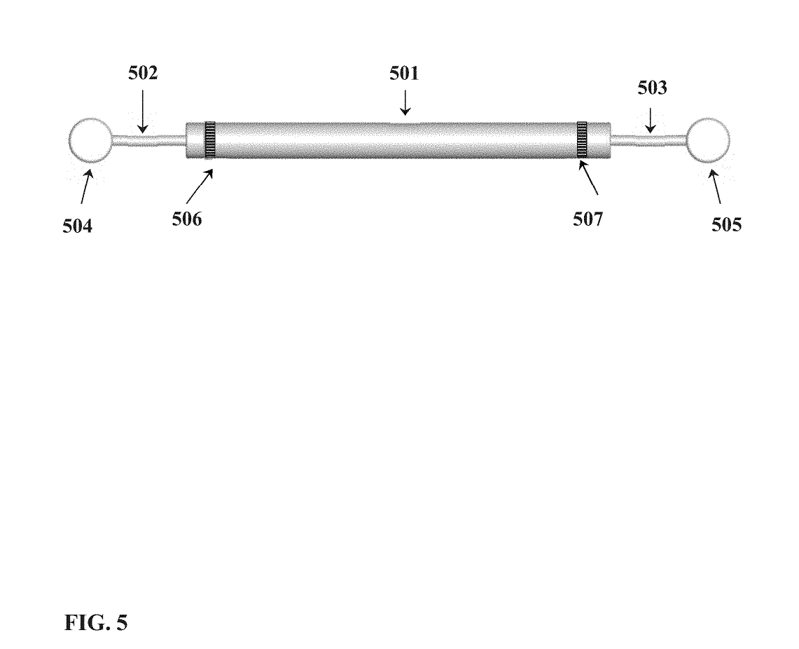

FIG. 5 depicts the hollow tube (501), comprising the piston input shaft (502), the piston out put shaft (503), the side view of the end handle grips (504), (505), and the air pressure adjustment valves (506) and (507) as might be found in the preferred embodiment of the present invention for example.

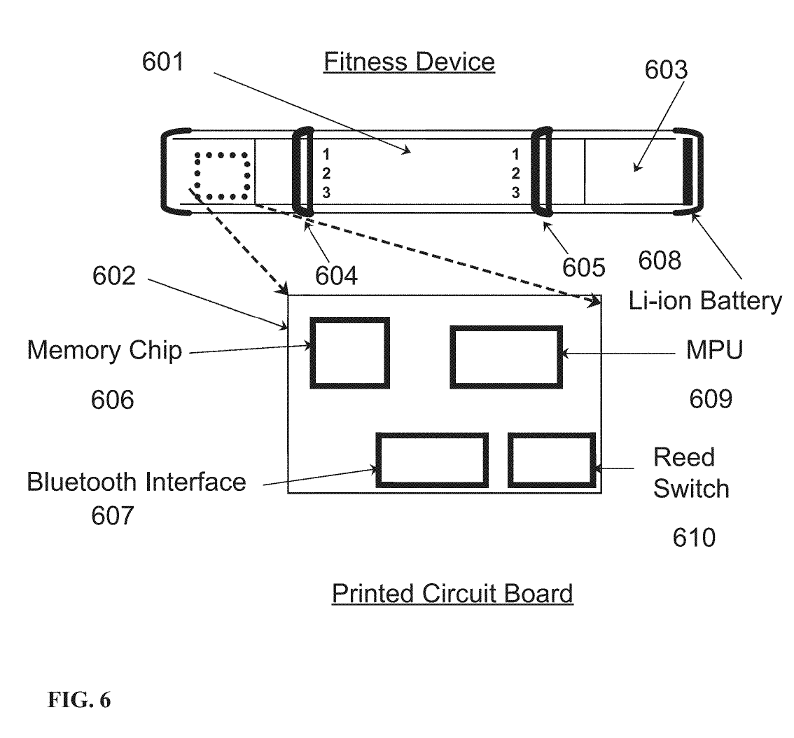

FIG. 6 depicts the hollow tube (601), the internal circuit board (602), the handle grip (603), the air intake adjustable pressure valve (604), and the air exhaust adjustable pressure valve as might be found in the preferred embodiment of the present invention for example.

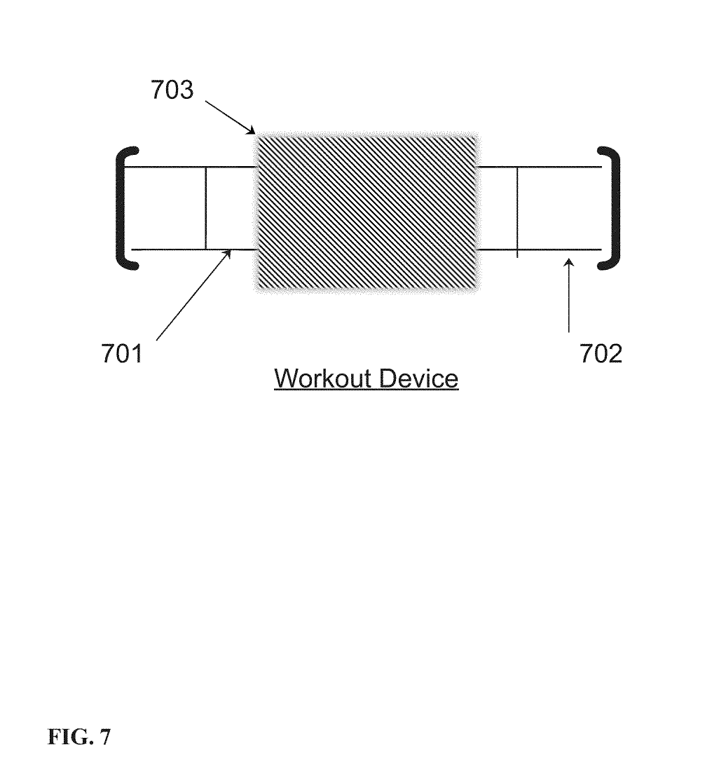

FIG. 7 depicts the hollow tube (701), the hand grip (702), and the removable velcro attachable leg muscle relaxer (703) for example as might be found in the preferred embodiment for example.

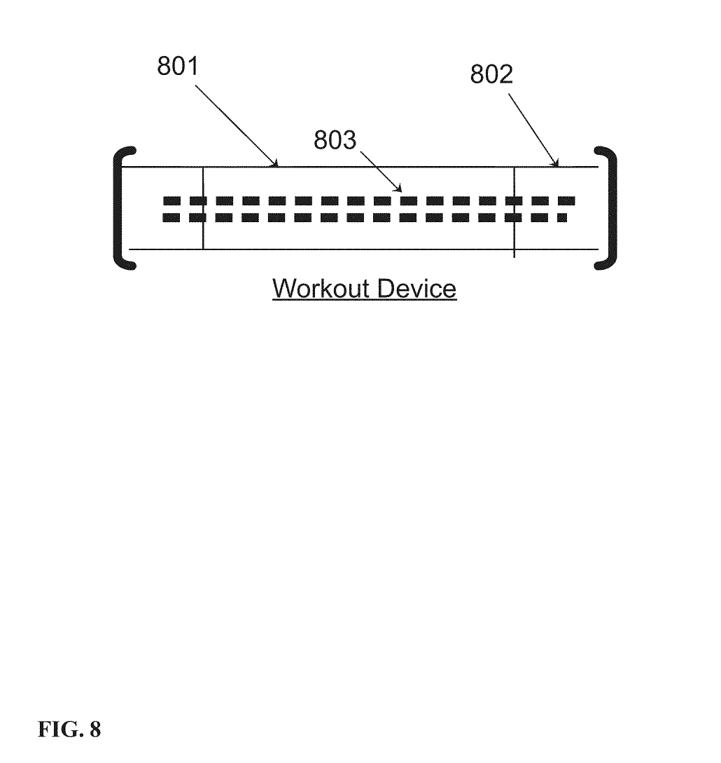

FIG. 8 depicts the hollow tube (801), the handle grip (802), and the modified work out device wherein the pneumatic or hydraulic plunger is replaced by a metal or rubber spring (803) for example in the preferred embodiment.

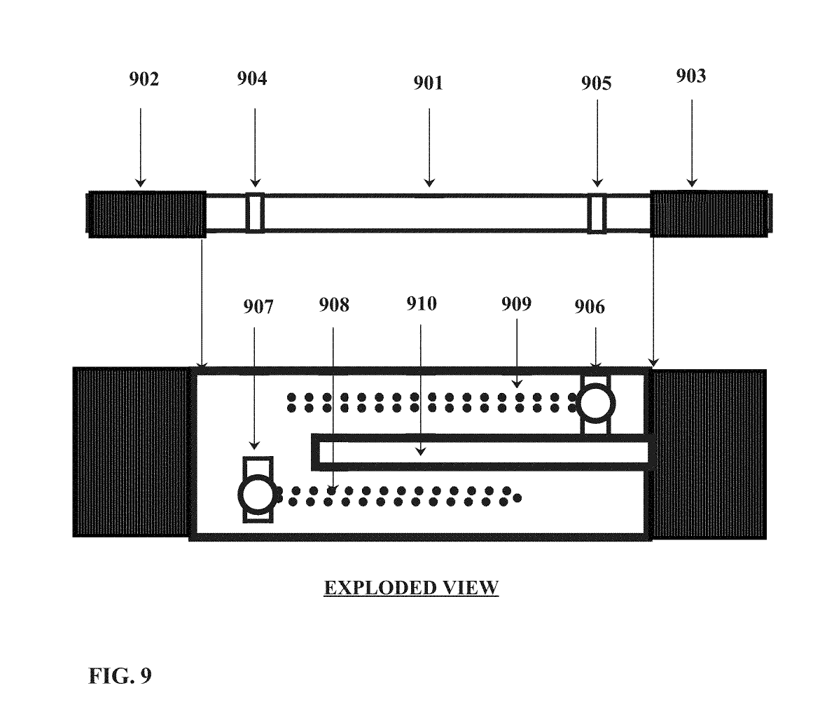

FIG. 9 depicts the hollow tube (901) and the two retractable handle grips (902) and (903) attached to the piston shaft (910) wherein the piston is comprised of permanent magnets, and the adjustable magnets (908) and (909) and are attached to two thumb screws (906) and (907) which gives the user a greater or lesser resistance in order to increase/decrease the force necessary to move the rods, which are adjustable by the said two rotatable type screws.

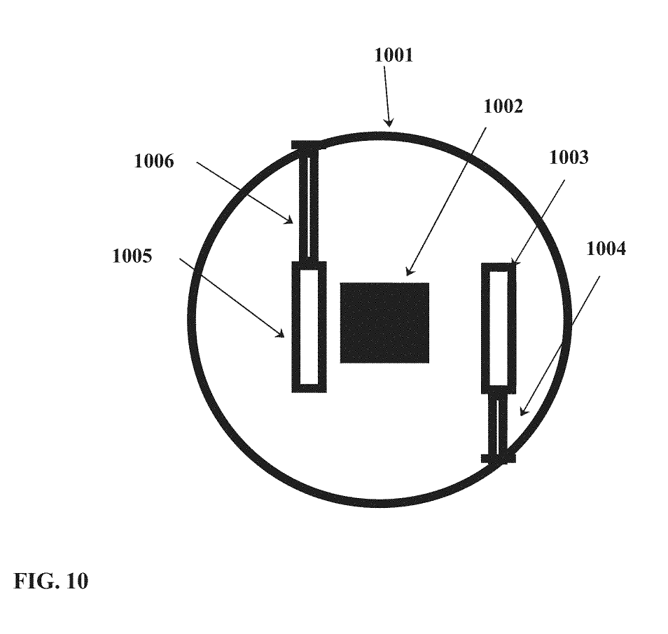

FIG. 10 depicts the internal side view of FIG. 9 (1001) showing the plunger having been replaced by the permanent magnet (1002) with the positioning of the moveable permanent magnets (1003) and (1005) held in place by metal brackets (1004) and (1006) fastened by the said thumb screws such that the force required can be adjusted by the user to control the amount of pressure required to collapse and expand the device as pictured in FIG. 9.

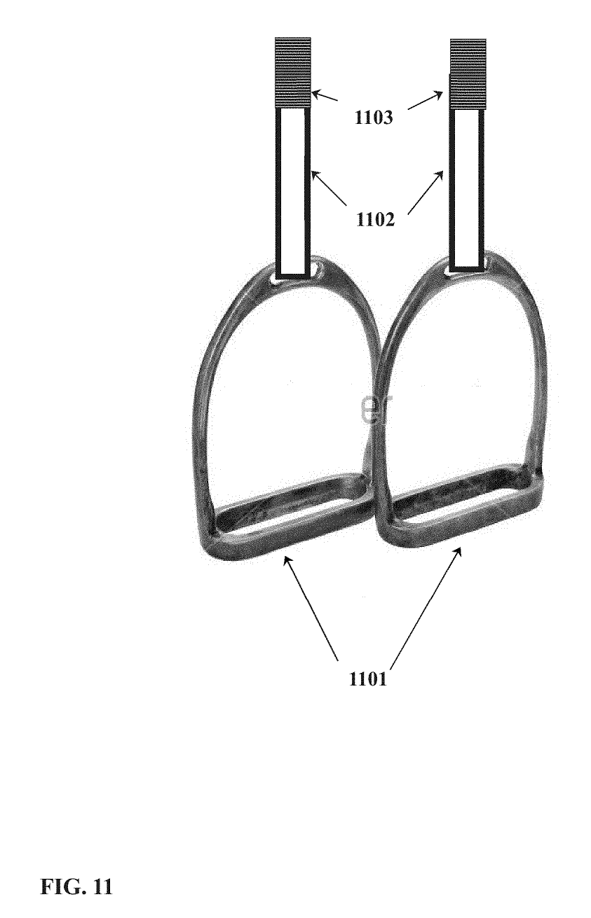

FIG. 11 depicts the replaceable handles resembling stirrups (1101) attached to connector rods (1102), that can be used to replace the handle grips on the device, for use of the device for to exercise the user's legs and lower body parts, comprising screws thread (1103) for easy removal and replacement.

I claim:

1. comprises a pneumatic upper body work out device wherein the device comprises a hollow tube, a piston shaft on each end attached to a plunger that connects to a pair of rotatable and retractable handles on either end such that the handles allow the user to position the handles to the comfort of the user in various positions during the workout routine. The pneumatic pressure is adjustable by use of two rotatable valves which restrict the air intake on the one end and the air exhaust on the other end thereby making the force required to compress or expand the device user selectable so the amount of energy required to complete the routine can be varied as may be necessary.

2. comprises all of the features of claim one except that the device operates by hydraulic fluid instead of by pneumatics.

3. comprises all of the features of claim 1 except that the device operates by a set of mechanical springs or rubberize bands internal to the device instead of by using pneumatics.

4. comprises all of the features of claim 1 except that the device operates by a set of magnets set up to pass over each other to create resistance. The two rotatable air valves are replaced by a pair of thumb screws.

5. comprises all of the features of claims 1 thru 4 with the exception that the device comprises an additional internal circuit board, a micro-processor, a memory chip, a bluetooth module, and a removable and internally rechargeable Li-Ion battery to power the electronics.

6. comprises all of the features of claims 1 thru 5 except that the device can be folded for ease of storage.

7. comprises all of the features of claims 1 thru 4 with the exception that the device has a removable outer sleeve that can be changed or removed to create a roller, to reduce leg cramps in the user as needed for muscle aches and pains, that can be removed and exchanged with a different color.

8. comprises all of the features of claims 1 thru 4 except that the handles may be removed and replaced, such that the length of the handles can be modified to suit the users needs or various exercise routines.
